(19) United States
(12) Patent Application Publication
(10) Pub. No.: US 2010/0052215 A1
(43) Pub. Date: Mar. 4, 2010

(54) Radio Frequency Identification Device for Plastic Container and Method of Manufacture of Same

(75) Inventors: Jean-Pierre Emond, Gainesville, FL (US); Khe Van Chau, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation , Inc., Gainesville, FL (US)

(21) Appl. No.: 12/279,583

(22) PCT Filed: Feb. 16, 2007
(86) PCT No.: PCT/US2007/004242

§ 371 Date: Oct. 21, 2009

Related U.S. Application Data
(60) Provisional application No. 60/774,263, filed on Feb. 16, 2006.

(51) Int. Cl. B29C 45/14

(52) U.S. Cl. 264/275

(57) ABSTRACT

The subject invention pertains to a method and system for identifying goods contained within a container. In an embodiment, a method of manufacturing a plastic container with an embedded RFID tag is provided. In an embodiment, a system includes a plastic container and plastic substrate, with an RFID tag disposed on the substrate. In an embodiment, the substrate can be embedded in a surface of the plastic container. In a further specific embodiment, the substrate can be a label used for in-mold labeling. Such a label can provide the labeling, or markings, for the container. Labeling the container and embedding an RFID tag during the same injection step can save time and costs.

### CROSS-REFERENCE TO RELATED APPLICATION

The present application claims the benefit of U.S. Provisional Application Ser. No. 60/774,263, filed Feb. 16, 2006, which is hereby incorporated by reference herein in its entirety, including any figures, tables, or drawings.

### BACKGROUND OF THE INVENTION

This invention is directed to the use of tags for containers, and more particularly, to the use of radio frequency identification (RFID) tags in connection with plastic molded containers.

With the advent of supply chain inventory tracking and automated merchandise handling, it has become important to identify products as they move through the distribution chain to the end use consumer. To aid the tracking process, the identification and tagging of goods, in a machine-readable way, has been developed. By way of example, optical codes such as the barcode have been developed to allow high speed optical scanning of identification tags associated with goods. However, barcodes suffer from the disadvantage that there must be a line of sight between the identification tag and the optical scanner. The line of sight may be obstructed by the environment in which the scan is taken (dust, dirt and smoke) or by the manner in which the products are shipped (stacked or densely packaged to block the line of sight to the tag).

To overcome the shortcomings of the optical scan tags, RFID tags have been used to identify goods. RFID tags utilize electronic or magnetic field communication between a receiver having a proximity antenna and the tag. As is known in the art, from U.S. Pat. No. 6,054,935 by way of example, a transponder usually includes a receive antenna for receiving an input signal and circuitry affixed to the transponder. The circuitry may include a programmable memory for retaining identification information associated with the goods to which it is attached and/or other properties of interest such as a thermistor to provide temperature data that is output through the antenna to the proximity antenna of a tag reading device.

To protect the circuitry, the RFID tag is often placed in its own housing and affixed to the goods with which it was to be associated. Although this tagging method can function satisfactorily, it can also suffer from the disadvantage of using an add-on device. Further, the RFID tag can be separated from the goods with which it has been associated and/or can be inadvertently switched between goods, therefore misidentifying the tagged goods. Furthermore, the cost of the housing and the apparatus, glue, bolts, screws, and/or other materials for attaching the RFID tag to the associated product increase the cost, the time of manufacture, and the number of steps required for the overall process.

Accordingly, there exists a need for a method and apparatus for RFID tagging items and a method of manufacture of a container incorporating an RFID tag, which can overcome one or more of the shortcomings of the prior art, are desired.

### BRIEF SUMMARY

The subject invention pertains to a method and system for identifying goods contained within a container. In an embodiment, a method of manufacturing a plastic container with an embedded RFID tag is provided. In an embodiment, a system includes a plastic container and plastic substrate, with an RFID tag disposed on the substrate. In an embodiment, the substrate can be embedded in a surface of the plastic container. In a further specific embodiment, the substrate can be a label used for in-mold labeling. Such a label can provide the labeling, or markings, for the container. Labeling the container and embedding an RFID tag during the same injection step can save time and costs.

During manufacture, a product label can be formed of a plastic film. The RFID tag can incorporate a circuit and an antenna. The tag can be affixed to the label via one or more of a variety of techniques such as via glue, via printing the antenna on the label, using another film layer to hold the RFID tag to the label, or adhering a substrate the RFID tag is affixed to the label. A circuit can be printed on the film. An antenna can be affixed to the circuit and attached to the film. The film or label with RFID structure formed thereon is placed in a mold. The film substrate is molded to a container to embed the substrate into the container.

Other sensor circuitry can also be affixed to the label prior to the injection of plastic to form the containers, such that the RFID tag and one or more other sensor circuitries are embedded in the container. Such sensor circuitries can include, but are not limited to a sensor sensitive to one or more materials, a sensor sensitive to one or more gases, a temperature sensor, a pH sensor, and a pressure sensor. Gases that can be sensed include, for example, oxygen, fermenting gases such as ethanol, and carbon dioxide. Detection of fermenting gases can be an indication of product in the container going bad. The sensors can be covered by a permeable membrane that faces the inside of the container so as to be in contact with the product or product environment in the container. A pressure or moisture sensor can allow detection of a break in the seal of the container.

Embedding RFID tags in an injection molded plastic container can allow control of the location of the tag on the container. RFID technology works best when the effects of the product inside the container on the readability of the RFID tag are controlled. As examples, water can absorb RF signal, metal can reflect RF signal, salt can prevent RF signal penetration, and round containers can suffer “focus” effect with dense wet food. The plastic containers from a single mold can be used for many types of product, such as food, liquids, or nails and having the ability to relocate the RFID tag for each product requirements enables the use of the same mold to produce containers for different products or uses. In addition, embedding of RFID tags may not be required for all plastic containers ordered by users. Embodiments of the invention can maintain the ability to produce “none RFID container” as well as “RFID container” from the same mold, by using labels without RFID tags or labels with RFID tags affixed in the same mold.

Embodiments of the invention use a labeling technique called “In Mold Labeling” (IML) for injection molding plastic container. The technique allows us to place the RFID tag on the label, or print the RFID tag on the label at the specific location requested by the users and embed the RFID tag during the labeling process in the correct location. Advantageously, current users of IML can accomplish the embedding of RFID tags in plastic containers without changing any current setting in their equipment.

The use of the label to position the tag allows the electrostatic technique for holding the label in position with respect to the mold, and therefore the resulting container, to be used to hold the tag in position as well. In another embodiment, a vacuum can be used to hold the label in place. Due to the large surface area of the label, the tag is held in proper position even during the very high shear stress and turbulence encountered during injection. In an embodiment, the label sits on the bottom of the mold, which can be the top or bottom of the container. Accordingly, it is preferable for the label to have a sufficiently large surface area such that the label does not move during injection. The label can, for example, cover 50% to 100% of the side of the container, more preferably 80% to 100% of the side of the container, and even more preferably 85% to 95% of the side of the container. In another embodiment, an RFID can be affixed to the label for the bottom of the container.

### BRIEF DESCRIPTION OF THE DRAWINGS

FIG. 1 is a perspective view of a container having an RFID tag attached to a side label.

FIG. 2 is a perspective view of a container having an RFID tag attached to a bottom label.

FIG. 3 is a front view of an RFID tag adhered to a side film label.

FIG. 4 is a sectional view of a production process in accordance with the subject invention.

### DETAILED DISCLOSURE

The subject invention pertains to a method and system for identifying goods contained within a container. In an embodiment, a method of manufacturing a plastic container with an embedded RFID tag is provided. In an embodiment, a system includes a plastic container and plastic substrate, with an RFID tag disposed on the substrate. In an embodiment, the substrate can be embedded in a surface of the plastic container. In a further specific embodiment, the substrate can be a label used for in-mold labeling. Such a label can provide the labeling, or markings, for the container. Labeling the container and embedding an RFID tag during the same injection step can save time and costs.

During manufacture, a product label can be formed of a plastic film. The RFID tag can incorporate a circuit and an antenna. The tag can be affixed to the label via one or more of a variety of techniques such as via glue, via printing the antenna on the label, using another film layer to hold the RFID tag to the label, or adhering a substrate the RFID tag is affixed to the label. A circuit can be printed on the film. An antenna can be affixed to the circuit and attached to the film. The film or label with RFID structure formed thereon is placed in a mold. The film substrate is molded to a container to embed the substrate into the container.

Other sensor circuitry can also be affixed to the label prior to the injection of plastic to form the containers, such that the RFID tag and one or more other sensor circuitries are embedded in the container. Such sensor circuitries can include, but are not limited to a sensor sensitive to one or more materials, a sensor sensitive to one or more gases, a temperature sensor, a pH sensor, and a pressure sensor. Gases that can be sensed include, for example, oxygen, fermenting gases such as ethanol, and carbon dioxide. Detection of fermenting gases can be an indication of product in the container going bad. The sensors can be covered by a permeable membrane that faces the inside of the container so as to be in contact with the product or product environment in the container. A pressure or moisture sensor can allow detection of a break in the seal of the container.

Embedding RFID tags in an injection molded plastic container can allow control of the location of the tag on the container. RFID technology works best when the effects of the product inside the container on the readability of the RFID tag are controlled. As examples, water can absorb RF signal, metal can reflect RF signal, salt can prevent RF signal penetration, and round containers can suffer “focus” effect with dense wet food. The plastic containers from a single mold can be used for many types of product, such as food, liquids, or nails and having the ability to relocate the RFID tag for each product requirements enables the use of the same mold to produce containers for different products or uses. In addition, embedding of RFID tags may not be required for all plastic containers ordered by users. Embodiments of the invention can maintain the ability to produce “none RFID container” as well as “RFID container” from the same mold, by using labels without RFID tags or labels with RFID tags affixed in the same mold.

Embodiments of the invention use a labeling technique called “In Mold Labeling” (IML) for injection molding plastic container. The technique allows us to place the RFID tag on the label, or print the RFID tag on the label at the specific location requested by the users and embed the RFID tag during the labeling process in the correct location. Advantageously, current users of IML can accomplish the embedding of RFID tags in plastic containers without changing any current setting in their equipment.

The use of the label to position the tag allows the electrostatic technique for holding the label in position with respect to the mold, and therefore the resulting container, to be used to hold the tag in position as well. In another embodiment, a vacuum can be used to hold the label in place. Due to the large surface area of the label, the tag is held in proper position even during the very high shear stress and turbulence encountered during injection. In an embodiment, the label sits on the bottom of the mold, which can be the top or bottom of the container. Accordingly, it is preferable for the label to have a sufficiently large surface area such that the label does not move during injection. The label can, for example, cover 50% to 100% of the side of the container, more preferably 80% to 100% of the side of the container, and even more preferably 85% to 95% of the side of the container. In another embodiment, an RFID can be affixed to the label for the bottom of the container.

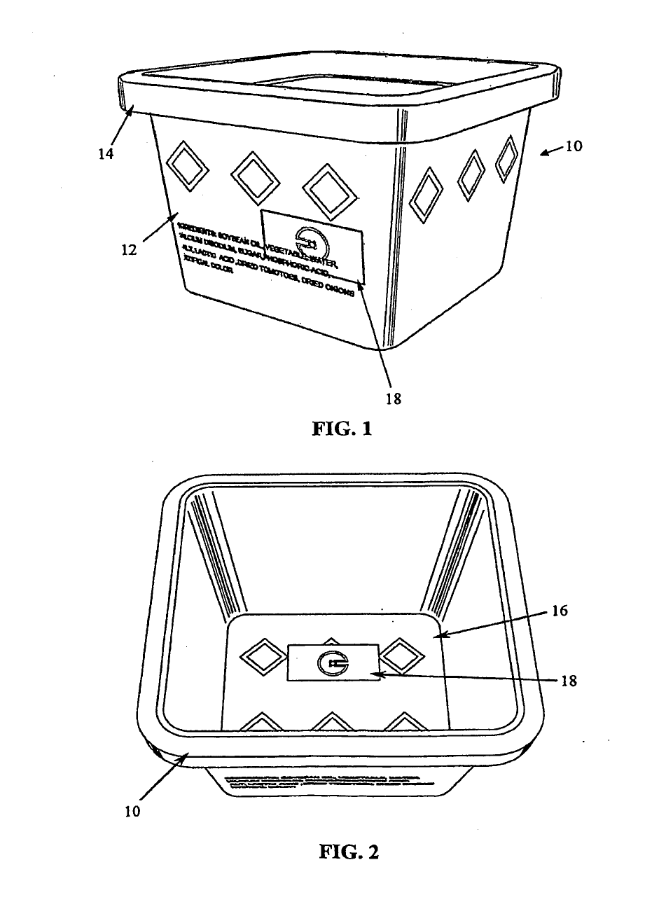

Reference is made to FIG. 1 in which a container, generally indicated as 10, is provided. Container 10 has a sidewall 12 and a lid 14 thereon. It should be noted, by way of example, that container 10 has a generally rectangular cross section, but can have other cross-sectional shapes. Container 10 may be formed of any shape applicable to containers. Container 10 need not have a lid 14. Furthermore, container 10 may be formed of plastic or some other material having at least one plastic surface, which supports an RFID tag.

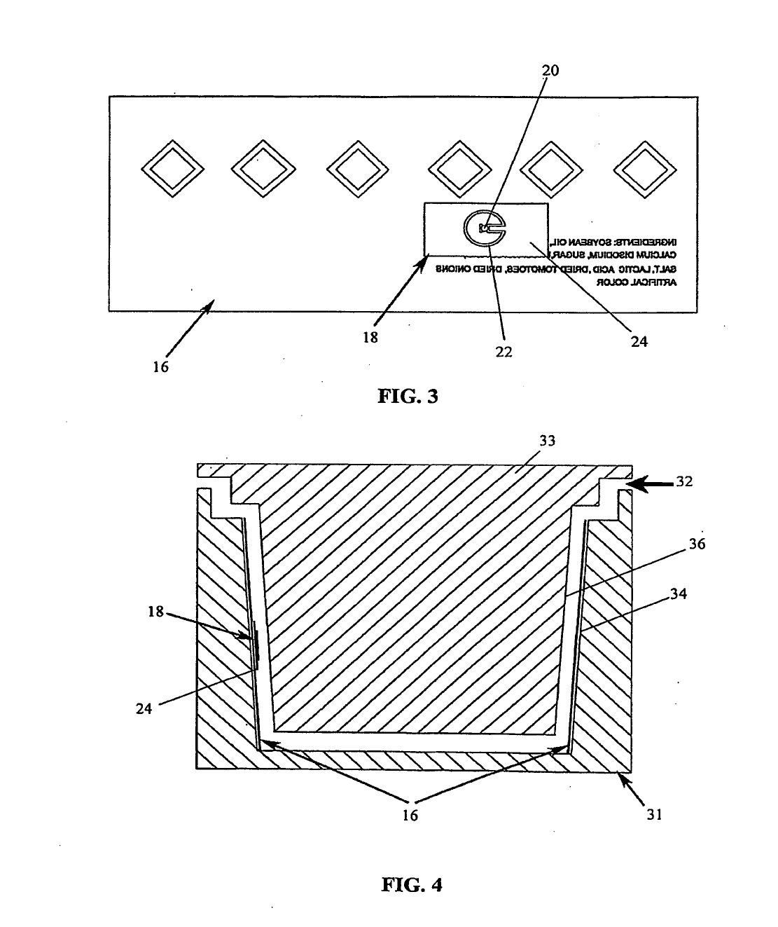

A label 16, as shown in FIG. 3, is integrally formed with a surface of sidewall 12, lid 14 or base, as shown in FIG. 2, of container 10. In a preferred embodiment, label 16 is molded into a sidewall 12 or lid 14 of container 10.

Referring to FIG. 3, an RFID tag, generally indicated as 18, is affixed to label 16, label 16 acting as a support substrate for RFID tag 18. RFID tag 18 includes a circuit 20 formed as a chip, as known in the art and an antenna 22 operatively connected to circuit 20. In the preferred embodiment, RFID tag 18 is disposed between label 16 and a surface of container 10, and is embedded in the surface of container 10.

Chip 20 is substantially small relative to the size of label 16, or the curvature, if any, of any surface such as sidewall 12 to which it is affixed so that the curvature or bend in the surface does not affect the operation or the ability of RFID tag 18 to remain affixed to label 16. Antenna 22 is formed of sufficiently malleable material, such as thin gauge wire, or conductive ink, so that it, with its relatively larger area, can conform to the shape of the surface of a sidewall 12 with the label 16 on which it is affixed without affecting overall operation of the RFID tag 18.

RFID tag 18 is mounted with label 16 and therefore it is molded to sidewall 12. It should be noted that RFID tag 18 may be affixed or embedded to either the inner surface or outer surface of sidewall 12 or in sidewall 12, as most plastics are radio frequency permeable allowing communication with the receiver and proximity antenna. Furthermore, as known in the art, circuit 20 may store the serial number or identification information associated with the container and the contents therein and can include sensors such as material monitor, gas monitor, temperature, humidity, pressure, and/or pH. In other words, when mounted either within the surface or on an interior surface of sidewall 12, lid 14 or the base, circuit 20 can identify and monitor the condition of the contents therein. Circuit 20 can monitor the ambient environmental characteristics to which container 10 is subjected providing additional information regarding the container.

Although the plastic may be transparent to electrical signals, the contents may not. By way of example, water affects the transmission of the radio frequency signals to the detector. Accordingly, in a preferred embodiment, label 16 and/or antenna 22 are mounted within sidewall 12 adjacent to lid 14 so that antenna 22 is sufficiently above the contents contained within container 10 to prevent radio frequency interference. They may also be mounted on lid 14 or the base if containers 10 are normally stacked in short layers of containers when residing on the shelves.

Reference is now made to FIGS. 1-4 in connection with the method of manufacture. As seen in FIG. 3, label 16 can have another film or sub-label 24 that can have an RFID tag affixed there to such that affixing the sub-label 24 to the label 16 affixes the RFID tag label 16. The sub-label can be placed over the RFID tag to hold the tag to label 16. In a specific embodiment, sub-label 24 can be a selectively permeable membrane to allow certain materials to pass therethrough. Label 16 is formed of a plastic film. The circuitry and antenna for RFID tag 18 can be printed on the plastic substrate formed by label 16. It should be noted that label 16 may be made from other materials such as paper, so long as it is sufficiently rigid to provide support for RFID tag 18, but not so rigid as to prevent it from conforming to the shape of the container during molding as will be discussed below. In other embodiments, RFID tag 18 may be a silicone chip affixed by welding, adhesive or resin to antenna 22, both of which may be laminated, glued, or resined to the substrate formed by label 16. In a preferred non-limiting embodiment, RFID tag 18 is affixed to the surface of label 16 opposite the surface supporting indicia, such as words and/or markings, so as not to interfere with the aesthetic and informational purpose of label 16.

As seen in FIG. 4, label 16 is then placed-within a mold 31 and 33 and an in-mold labeling process is performed. The label is supported within the mold (FIG. 4) and plastic is injected into the form formed by mold 31 and 33, forming a container behind the substrate and a bond with the substrate. The mold forms a unitary-labeled container 10, including label 16 and RFID tag 18. It should be noted that the in-mold labeling process was described, however, the embedding process in which the label is formed into the container can also be performed using an injection molding with film in a mold process or extrusion blow molding with film in the mold.

As a result of the molding process, once container 10 has been formed, label 16 is embedded in a surface of container 10. Because label 16 is part of container 10, RFID tag 18 is permanently attached to container 10 while providing an identification mechanism. By printing the antenna on label 16, antenna 22 can be expanded to correspond with a significant portion of label 16, decreasing the likelihood that the contents of contain 10 will interfere with transmission of signals from and to RFID tag 18.

In a non-limiting preferred embodiment, RFID tag 18 is positioned within the mold between label 16 and the to be formed container 10. When transponder RFID tag 18 is disposed between label 16 and sidewall 12, it too becomes embedded in container 10. Although FIG. 4 shows one orientation of tag 18 affixed to a sub-label 24, which is affixed to label 16, and having label 16 held in position on the wall 34 of the mold 31 and 33 that corresponds to the outside surface of the container 10, other orientations are possible. Label 16 can be held in place on wall 36 corresponding to the inside surface of the container 10. Tag 18 can be affixed directly to label 16, either toward an exterior surface of the container wall 12 or toward the interior of container wall 12. The RFID tag circuit 20 and antenna 22 can be located between label 16 and sub-label 24, where sub-label 24 can hold the circuit 20 and antenna 22 in place with respect to label 16. It should be noted that RFID tag 18 has been used to refer to the RFID tag and that RFID tag 18 includes circuit 20 and antenna 22, and optionally can be affixed to a sub-label 24. In an embodiment incorporating one or more sensors, these sensors can be positioned with respect to label 16 with the assistance of a sub-label 24 used to position the RFID tag, such that the sensor is near the RFID tag, or another sub-label 24 can be used to position the sensor with respect to label 16. In a specific embodiment, the sensor is affixed to label 16 with a sub-label 24 that is a selectively permeable membrane and the label is positioned on wall 36 so that the selectively permeable membrane is toward the inside of the container and can contact the product in the container and/or the environment in the container. Alternatively, the label 16 can be selectively permeable and the sensor can be toward the interior of wall 12 from label 16, while label 16 is located on the inside of the container 10. Substrate 16 is selected to be compatible with the type of plastic or the shaping process, such as high temperature, high turbulence, high pressure or the like to optimize the fusion between the RFID tag 18 and container 10 as RFID tag 18 becomes embedded in container 10 during the molding process. Again, substrate 16 can be placed within mold 26 so that the final product in container 10 positions film 16 outside the container like a label or inside the container like an inner film lining. In this way, RFID tag 18 can use the inner surface for better positioning for antenna 22, or to measure parameters within the container.

By selecting the appropriate substrate 16, the process and RFID tag 18 lend themselves to packages for use in foods, pharmaceutical products, or larger containers for individually labeled use in places such as warehouses, hospitals, pharmacies or the like, and even containers for handling during shipping. By molding label 16 and/or RFID tag 18 into the plastic structure of container 10, the RFID tag 18 becomes part of the container and cannot be interchanged like the prior art labels or tags. By disposing RDID tag 18 between a sidewall 12 and label 16, RFID tag 18 is protected from inadvertent dislodging, breakage or the corrosive effects of the environment. It should be noted that molding onto sidewall 12 is by way of example. RFID tag 18 can be just as easily molded to a plastic lid 14 for the container.

Thus, while there have been shown, described and pointed out novel features of the present invention as applied to preferred embodiments thereof, it will be understood that various omissions and substitutions and changes in the form and detail of the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language, might be said to fall there between.

All patents, patent applications, provisional applications, and publications referred to or cited herein are incorporated by reference in their entirety, including all Figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method for embedding a radio frequency identification (RFID) tag in a plastic container, comprising:
affixing a RFID tag to a label for in mold labeling;
placing the label in a mold defining a cavity for a plastic container, wherein the label is held in place;
injecting polymeric material into the mold to form the plastic container, wherein the RFID tag is embedded in the container.

2. The method according to claim 1, wherein affixing the RFID tag to the label for in mold labeling comprises printing an antenna for RFID on the label.

3. The method according to claim 1, wherein affixing the RFID tag to the label for in mold labeling comprises adhering the RFID tag to the label.

4. The method according to claim 1, further comprising affixing one or more additional RFID tags to the label prior to injecting polymeric material into the mold, wherein the one or more additional RFID tags are embedded in the container.

5. The method according to claim 1, further comprising:
affixing a second RFID tag to a second label for in mold labeling, and
placing the second label in the mold prior to injecting polymeric material into the mold.

6. The method according to claim 1, wherein placing the label in a mold defining a cavity for a plastic container comprises:
placing the label in the mold such that the label is positioned on a bottom surface of the plastic container.

7. The method according to claim 1, wherein placing the label in a mold defining a cavity for a plastic container comprises:
placing the label in the mold such that the label is positioned on an inside surface of the plastic container.

8. The method according to claim 7, wherein the RFID tag is affixed to an inner surface of the label such that the RFID tag is away from the inside surface of the plastic container with respect to the label.

9. The method according to claim 7, wherein the RFID tag is affixed to an outer surface of the label such that the RFID tag is toward the inside surface of the plastic container with respect to the label.

10. The method according to claim 9, further comprising affixing a selectively permeable film to the label over the RFID tag, wherein the selective permeability film is on the inner surface of the container.

11. The method according to claim 10, further comprising positioning a sensor for detection of at least one of chemicals, pressure, temperature, pH, or gas through the selective permeability film between the label and the selectively permeable film.

12. The method according to claim 1, wherein placing the label in a mold defining a cavity for a plastic container comprises:
placing the label in the mold such that the label is positioned on an outside surface of the plastic container.

13. The method according to claim 12, wherein the RFID tag is affixed to an inner surface of the label such that the RFID tag is away from the outside surface of the plastic container with respect to the label.

14. The method according to claim 12, wherein the RFID tag is affixed to an outer surface of the label such that the RFID tag is toward the outside surface of the plastic container with respect to the label.

15. The method according to claim 1, wherein the label is held in place electrostatically.

16. The method according to claim 1, wherein the label is held in place by a vacuum.

17. The method according to claim 1, wherein surface area of the label is sufficient to prevent movement of the label during injecting of the polymeric material into the mold.

18. The method according to claim 17, wherein the surface area of the label is 50% to 100% of a surface area of a side of the plastic container where the label is positioned.

19. The method according to claim 17, wherein the surface area of the label is 80% to 100% of a surface area of a side of the plastic container where the label is positioned.

20. The method according to claim 17, wherein the surface area of the label is 90% to 100% of a surface area of a side of the plastic container where the label is positioned.
